(19) United States
(12) Patent Application Publication
(10) Pub. No.: US 2023/0197971 A1
(43) Pub. Date: Jun. 22, 2023

(54) FUEL CELL COMPONENT INCLUDING POLYTETRAFLUOROETHYLENE FILM BONDED TO GRAPHITE

(71) Applicant: DOOSAN FUEL CELL AMERICA, INC., SOUTH WINDSOR, CT (US)

(72) Inventors: Benjamin SILVERMAN, South Windsor, CT (US); Timothy William PATTERSON, West Hartford, CT (US); Eric LIVIACH, South Windsor, CT (US); Jonathan ODELL, Agawam, MA (US)

(21) Appl. No.: 17/552,607

(22) Filed: Dec. 16, 2021

(51) Int. Cl. H01M 4/86; H01M 4/04; H01M 4/36; H01M 4/96

(52) U.S. Cl. CPC H01M 4/8657; H01M 4/043; H01M 4/366; H01M 4/8668; H01M 4/96

(57) ABSTRACT

An illustrative example embodiment of method of making a fuel cell component includes placing a graphite substrate and a polytetrafluoroethylene (PTFE) layer in a heated press with a fluoroelastomer adhesive between the graphite substrate and the PTFE layer; pressing the PTFE layer, the fluoroelastomer adhesive and the graphite substrate together using the heated press; removing the graphite substrate, the fluoroelastomer adhesive and the PTFE layer from the heated press; and allowing the graphite substrate, the fluoroelastomer adhesive, and the PTFE layer to cool.

### BACKGROUND

Fuel cells generate electricity based on an electrochemical reaction between reactants such as hydrogen and oxygen. Fuel cell devices include a number of fuel cells in a cell stack assembly. One issue associated with liquid electrolyte fuel cells is managing the electrolyte, such as phosphoric acid, within the cell stack assembly. Achieving desired performance and life of the cell stack assembly requires maintaining adequate electrolyte throughout the stack and preventing acid migration from one cell to the next cell in the stack.

One approach for preventing electrolyte migration is to include fluid-impervious barriers or seals along edges of at least some of the fuel cell components, such as flow field plates. Different methodologies have been proposed for establishing such seals. Even when such seals are effective, the challenge of reducing the cost of fuel cells remains. Approaches that include additional manufacturing steps or that introduce additional time into the assembly process contribute to increased cost and are, therefore, less than ideal.

### SUMMARY

An illustrative example embodiment of method of making a fuel cell component includes placing a graphite substrate and a polytetrafluoroethylene (PTFE) layer in a heated press with a fluoroelastomer adhesive between the graphite substrate and the PTFE layer; pressing the PTFE layer, the fluoroelastomer adhesive and the graphite substrate together using the heated press; removing the graphite substrate, the fluoroelastomer adhesive and the PTFE layer from the press; and allowing the graphite substrate, the fluoroelastomer adhesive, and the PTFE layer to cool.

An example embodiment having one or more features of the method of the previous paragraph includes applying the fluoroelastomer adhesive to a portion of the graphite substrate and placing the PTFE layer in contact with the fluoroelastomer adhesive.

In an example embodiment having one or more features of the method of any of the previous paragraphs, applying the fluoroelastomer adhesive comprises applying a bead of the fluoroelastomer adhesive to the portion of the graphite substrate.

In an example embodiment having one or more features of the method of any of the previous paragraphs, the fluoroelastomer adhesive comprises a caulk.

In an example embodiment having one or more features of method of any of the previous paragraphs, the heated press has a temperature greater than 150° C. (300° F.) and less than 200° C. (400° F.) during the pressing.

In an example embodiment having one or more features of the method of any of the previous paragraphs, the temperature is 170° C. (340° F.).

In an example embodiment having one or more features of the method of any of the previous paragraphs, the pressing is performed for less than one minute.

In an example embodiment having one or more features of the method of any of the previous paragraphs, the pressing is performed for 30 seconds.

In an example embodiment having one or more features of the method of any of the previous paragraphs, allowing the graphite substrate, fluoroelastomer adhesive, and the PTFE layer to cool comprises exposing the graphite substrate, the fluoroelastomer adhesive, and the PTFE layer to an ambient temperature.

In an example embodiment having one or more features of the method of any of the previous paragraphs, allowing the graphite substrate, fluoroelastomer adhesive, and the PTFE layer to cool is performed for 1 minute.

An example embodiment having one or more features of the method of any of the previous paragraphs includes avoiding applying pressure to the PTFE layer between the placing and the pressing.

An example embodiment having one or more features of the method of any of the previous paragraphs includes treating at least one side of the PTFE layer prior to placing the PTFE layer in the heated press.

In an example embodiment having one or more features of the method of any of the previous paragraphs, treating the at least one side of the PTFE layer comprises etching the at least one side.

In an example embodiment having one or more features of the method of any of the previous paragraphs, treating the at least one side of the PTFE layer comprises applying a silica coating to the at least one side.

An illustrative example embodiment of a fuel cell component includes a graphite substrate and a polytetrafluoroethylene (PTFE) layer adjacent a portion of the graphite substrate, and a fluoroelastomer adhesive bonding the PTFE layer to the graphite substrate. At least one side of the PTFE layer that faces the graphite substrate includes a treated surface configured to make the PTFE layer bondable to the graphite substrate.

In an example embodiment having one or more features of the fuel cell component of the previous paragraph, the treated surface comprises a silica coating.

In an example embodiment having one or more features of the fuel cell component of any of the previous paragraphs, the treated surface has been etched.

In an example embodiment having one or more features of the fuel cell component of any of the previous paragraphs, the fluoroelastomer comprises a bead of caulk applied to the graphite substrate.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates a selected portion of an example cell stack assembly including fuel cell components designed according to an example embodiment.

FIG. 2 diagrammatically illustrates a selected portion of another example cell stack assembly including fuel cell components designed according to another example embodiment.

FIG. 3 illustrates a portion of a method of making an example embodiment of a fuel cell component.

FIG. 4 illustrates another portion of the method of making the fuel cell component shown in FIG. 3.

FIG. 5 schematically illustrates another portion of the method of making the fuel cell component shown in FIGS. 3 and 4.

FIG. 6 is a flow chart diagram summarizing the method represented in FIGS. 3-5.

### DETAILED DESCRIPTION

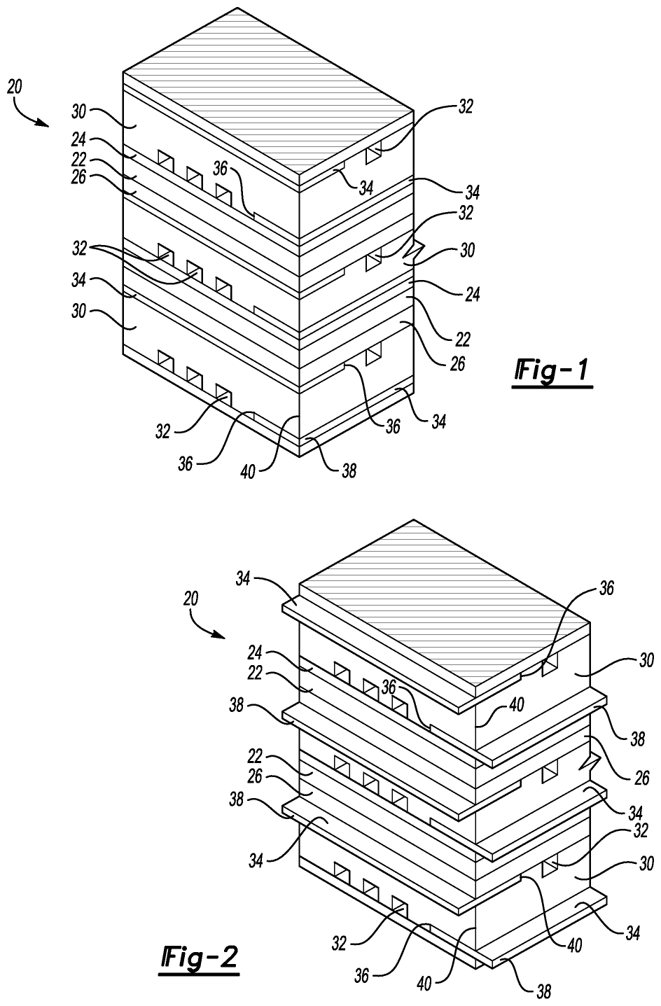

FIG. 1 diagrammatically illustrates selected portions of a cell stack assembly 20 including a plurality of fuel cells. Each fuel cell includes multiple fuel cell components. An electrolyte membrane 22 is situated between electrodes 24, 26. In some embodiments, the electrolyte membrane 22 includes a matrix containing a liquid electrolyte, such as phosphoric acid. Flow field plates 30 comprise graphite and include flow field channels 32 for distributing a reactant fluid, such as hydrogen or oxygen, to the adjacent electrodes 24, 26. In the illustrated example, the flow field plates 30 are part of a separator plate assembly that includes flow field channels 32 on opposite sides. Other embodiments include flow field plates and separator plates that are distinct components.

A hydrophobic layer 34, which comprises polytetrafluoroethylene (PTFE) in this embodiment, is included along at least some of the edges of the flow field plates 30. The PTFE layers 34 are adhesively secured to the graphite substrate of the flow fields 30 by a fluoroelastomer adhesive between the PTFE layer 34 and the graphite substrate.

In the example embodiment shown in FIG. 1, the PTFE layers 34 provide a seal along the corresponding edges of the flow field plates 30. The PTFE layers 34 include a first edge 36 that faces toward and is received against an adjacent surface of the graphite substrate of the flow field plate 30. A second edge 38 of each PTFE layer 34 is spaced from the first edge 36. In FIG. 1, the second edges 38 are aligned with corresponding edges 40 of the flow field plates 30.

Another example cell stack assembly 20 is shown in FIG. 2. In this example, the PTFE layers 34 extend beyond edges of the flow field plates 30. The second edges 38 of the PTFE layers are laterally outward of the edges 40 of the flow field plates 30. The edges 40 are aligned with the outside edges of the electrodes 24, 26. The protruding or extending portions of the PTFE layers 34 serve as barriers to liquid electrolyte (e.g., phosphoric acid) migration between and among the cells in the cell stack assembly 20.

In FIGS. 1 and 2, the PTFE layers 34 are at least partially received in a recess or land along the corresponding edges 40 of the graphite substrate of the corresponding flow field plates. Other fuel cell components that have a graphite substrate and a PTFE layer 34 do not include a land for receiving the PTFE layer 34.

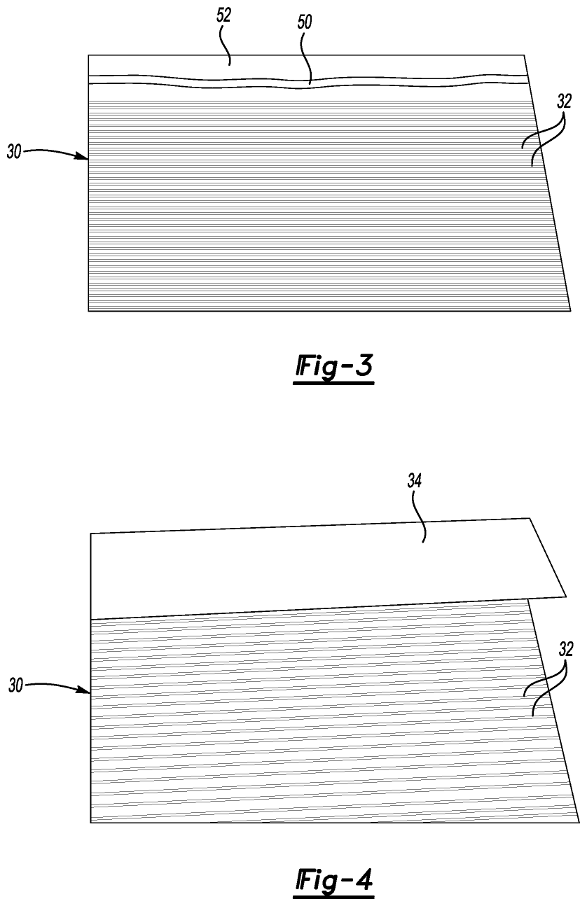

FIG. 3 shows an example flow field plate 30 that includes the flow field channels 32. A bead of fluoroelastomer adhesive 50 is applied to a portion 52 of the flow field plate 30. An example type of fluoroelastomer adhesive 50 that is useful in some embodiments is sold under the trade designation PELSEAL® 2112. In some embodiments, the portion 52 comprises a recess or land configured to correspond to and receive at least some of the PTFE layer 34. The fluoroelastomer adhesive 50 in this example embodiment comprises a caulk that is applied across the entire length of the portion 52.

FIG. 4 shows the PTFE layer 34 placed in contact with the fluoroelastomer adhesive 50. There is spacing between the PTFE layer 34 and portion 52 of the graphite substrate of the flow field plate 30 corresponding to the thickness of the bead of the fluoroelastomer adhesive 50. The PTFE layer 34 is not pressed toward the portion 52 in a manner that would compress or flatten the bead of fluoroelastomer adhesive 50 in the condition shown in FIG. 4.

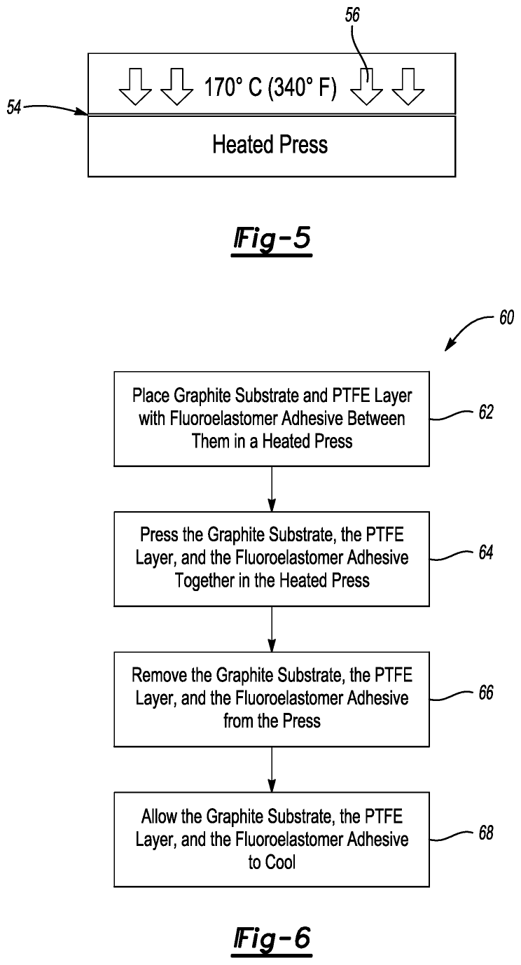

The flow field plate 30, the fluoroelastomer adhesive 50 and the PTFE layer 34 as shown in FIG. 4 are all placed into a heated press 54 as shown in FIG. 5. The heated press 54 is used to apply pressure schematically represented by the arrows 56 to press the PTFE layer 34 and the portion 52 of the flow field plate 30 toward each other. The fluoroelastomer adhesive 50, the PTFE layer 34 and at least the portion 52 of the flow field plate 30 are exposed to a temperature of approximately 170° C. (340° F.) while the pressure 56 is applied. The heated press 54 in some embodiments has a temperature in a range between 150° C. (300° F.) and 200° C. (400° F.) during the pressing. Some example embodiments include applying pressure within the heated press 54 for one minute.

Heating the fluoroelastomer adhesive 50 while applying such pressure allows volatile organic compounds to quickly escape and minimizes or prevents bubble formation between the PTFE layer 34 and the portion 52 of the flow field plate 30. If pressure were applied to compress the fluoroelastomer adhesive 50 and bring the PTFE layer 34 into contact with the portion 52 at a cooler temperature, such as room temperature, bubbles would form that would interrupt the bond between the PTFE layer 34 and the flow field plate 30. With the disclosed example process, a secure bond is established along the entire interface between the PTFE layer 34 and the portion 52 of the flow field plate 30.

The fuel cell component, which includes the PTFE layer 34 bonded to the portion 52 by the fluoroelastomer adhesive 50, is removed from the heated press 54 and allowed to cool at room temperature. The bond between the PTFE layer 34 and the portion 52 is sufficiently strong that the fuel cell component can be lifted using suction or a vacuum applied to the PTFE layer 34 without separating the PTFE layer 34 from the portion 52.

FIG. 6 is a flow chart diagram 60 that summarizes an example method of making a fuel cell component, such as the flow field plates 30 of the illustrated example embodiments. The graphite substrate and PTFE layer 34 with the fluoroelastomer adhesive 50 between them are placed in the heated press at 62. Next, the graphite substrate and PTFE layer 34 with the fluoroelastomer adhesive 50 between them are pressed together by applying pressure within the heated press at 64. At 66, the fuel cell component including the PTFE layer 34 bonded to the portion 52 is removed from the press at 66. The fuel cell component is allowed to cool at 68.

The entire process summarized in FIG. 6 takes less than a few minutes and results in a fuel cell component having a PTFE layer bonded to a graphite substrate sufficiently to allow for further handling and incorporating the component into a fuel cell and a cell stack assembly. The process is efficient and effective, providing an economical way to make a fuel cell component including a hydrophobic layer bonded to at least a portion of a graphite substrate.

The flow field plates 30 including at least one PTFE layer 34 are one example type of fuel cell component that can be made according to an embodiment of this invention. Other types of fuel cell components that require or would benefit from including a PTFE layer bonded to a graphite substrate can be made in the same or a very similar way.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of making a fuel cell component, the method comprising:
placing a graphite substrate and a polytetrafluoroethylene (PTFE) layer in a heated press with a fluoroelastomer adhesive between the graphite substrate and the PTFE layer;
pressing the PTFE layer, the fluoroelastomer adhesive and the graphite substrate together using the heated press;
removing the graphite substrate, the fluoroelastomer adhesive and the PTFE layer from the heated press; and
allowing the graphite substrate, the fluoroelastomer adhesive, and the PTFE layer to cool.

2. The method of claim 1, comprising
applying the fluoroelastomer adhesive to a portion of the graphite substrate; and
placing the PTFE layer in contact with the fluoroelastomer adhesive.

3. The method of claim 2, wherein applying the fluoroelastomer adhesive comprises applying a bead of the fluoroelastomer adhesive to the portion of the graphite substrate.

4. The method of claim 3, wherein the fluoroelastomer adhesive comprises a caulk.

5. The method of claim 1, wherein the heated press has a temperature greater than 150° C. (300° F.) and less than 200° C. (400° F.) during the pressing.

6. The method of claim 5, wherein the temperature is 170° C. (340° F.).

6. The method of claim 5, wherein the pressing is performed for less than one minute.

8. The method of claim 7, wherein the pressing is performed for 30 seconds.

9. The method of claim 1, wherein allowing the graphite substrate, fluoroelastomer adhesive, and the PTFE layer to cool comprises exposing the graphite substrate, the fluoroelastomer adhesive, and the PTFE layer to an ambient temperature.

10. The method of claim 9, wherein allowing the graphite substrate, fluoroelastomer adhesive, and the PTFE layer to cool is performed for 1 minute.

11. The method of claim 1, comprising avoiding applying pressure to the PTFE layer between the placing and the pressing.

12. The method of claim 1, comprising treating at least one side of the PTFE layer prior to placing the PTFE layer in the heated press.

13. The method of claim 12, wherein treating the at least one side of the PTFE layer comprises etching the at least one side.

14. The method of claim 12, wherein treating the at least one side of the PTFE layer comprises applying a silica coating to the at least one side.

15. A fuel cell component, comprising:
a graphite substrate;
a polytetrafluoroethylene (PTFE) layer adjacent a portion of the graphite substrate, at least one side of the PTFE layer that faces the graphite substrate includes a treated surface configured to make the PTFE layer bondable to the graphite substrate; and
a fluoroelastomer adhesive bonding the PTFE layer to the graphite substrate.

16. The fuel cell component of claim 15, wherein the treated surface comprises a silica coating.

17. The fuel cell component of claim 15, wherein the treated surface has been etched.

18. The fuel cell component of claim 15, wherein the fluoroelastomer comprises a bead of caulk applied to the graphite substrate.
